(19) United States
(12) Patent Application Publication
(10) Pub. No.: US 2017/0127151 A1
(43) Pub. Date: May 4, 2017

(54) Method and Device for Protecting Video Digital Copyrights

(71) Applicants: Le Holdings (Beijing) Co., Ltd., Beijing (CN); Le Shi Zhi Xin Electronic Technology (Tianjin) Limited, Tianjin (CN)

(72) Inventor: Hong Cao, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/241,982

(22) Filed: Aug. 19, 2016

Related U.S. Application Data
(63) Continuation of application No. PCT/CN2016/088843, filed on Jul. 6, 2016.

(30) Foreign Application Priority Data
Oct. 29, 2015 (CN) 201510717784.4

(51) Int. Cl. H04N 21/8358; H04N 21/258; H04N 21/441; H04N 21/475; G06F 21/16; H04N 21/4627

(52) U.S. Cl. CPC H04N 21/8358; G06F 21/16; H04N 21/4627; H04N 21/441; H04N 21/4753; H04N 21/25816; H04N 21/25875

(57) ABSTRACT

Embodiments of the present disclosure disclose an electronic device, method, system, and computer-readable medium for protecting video digital copyrights, comprising: acquiring a user identity requesting to play a video and a video play identity, using the user identity as a two-dimensional code to generate a parameter; generating a two-dimensional code, which is decoded to obtain the user identity; and overlapping the two-dimensional code on a designated video frame that plays the video play identity. In particular, the two-dimensional code is generated through the user identity, and the two-dimensional code is overlapped on the video frame. When the video is bootlegged, a bootlegged frame will contain the two-dimensional code; therefore, the user identity is obtained from the two-dimensional code conveniently, thus ascertaining a bootlegging source. Resources needed for coding and decoding the two-dimensional code are fewer than resources consumed by a watermark way; therefore, cost for preventing bootlegging can be reduced.

### CROSS REFERENCE TO RELATED APPLICATIONS

This application is a continuation of International Application No. PCT/CN2016/088843, filed on Jul. 6, 2016, which is based upon and claims priority to Chinese Patent Application No. 201510717784.4, filed on Oct. 29, 2015, the entire contents of which are incorporated herein by reference.

### TECHNICAL FIELD

The present disclosure relates to a field of a video-related technology, and more particularly, to a method and a system for protecting video digital copyrights.

### BACKGROUND

Digital rights management (DRM) refers to some technologies used by publishers for controlling a usage right of a protected object, and these technologies protect digitalized contents (for example: software, music and movie) and hardware, and process use limitation of a certain example of digitalized products. A DRM protection technology, while being used, may control and limit the usage right of these digitalized medium contents.

It is found by the inventor during a process of implementing the present disclosure that the existing DRM technology mainly protects a transmission process of video data; however, when a video is played through a display device such as a smart TV, pirates may pirate the video in a bootlegging way, for example, using a high-definition camera to record a program thereof to be pirated.

With respect to bootlegging, a current solution is to use a watermark method to prevent such actions. According to the method, a watermark is embedded in a video image without affecting the quality of the video; when the video is pirated, copyright information of the content may be identified through information hidden in the video frame.

However, the watermark technology has a complicated algorithm that requires a device to have a stronger processing capacity, such that the cost become higher. Therefore, the watermark is usually pressed by a video provider while providing the video, but the pressing speed is slow and online pressing is difficult to support; therefore, the watermark technology can only be used for playing an existing video like a movie usually. For a live program, it is difficult for the existing watermark technology to implement pressing simultaneously during live telecast.

### SUMMARY

On this basis, it is necessary to provide a method and a system for protecting video digital copyrights, to solve the technical problem of the method for preventing bootlegging in the prior art that has a complicated algorithm and a high cost.

According to a first aspect of the present disclosure, the present disclosure provides a method for protecting video digital copyrights by an electronic device, comprising: acquiring a user identity and a video play identity for requesting to play a video, and using the user identity as a two-dimensional code to generate a parameter; generating a two-dimensional code according to the user identity, the two-dimensional code being decoded to obtain the user identity; and overlapping the two-dimensional code on a designated video frame that plays the video play identity.

According to a second aspect of the present disclosure, the present disclosure provides a non-transitory computer-readable storage medium storing executable instructions that, when executed by an electronic device with a touch-sensitive display, cause the electronic device to: acquire a user identity and a video play identity for requesting to play a video, and use the user identity as a two-dimensional code to generate a parameter; generate a two-dimensional code according to the user identity, the two-dimensional code being decoded to obtain the user identity; and overlap the two-dimensional code on a designated video frame that plays the video play identity.

According to a third aspect of the present disclosure, the present disclosure provides an electronic device for protecting video digital copyrights, comprising: at least one processor; and a memory communicably connected with the at least one processor for storing instructions executable by the at least one processor, wherein execution of the instructions by the at least one processor causes the at least one processor to: acquire a user identity and a video play identity for requesting to play a video, and use the user identity as a two-dimensional code to generate a parameter; generate a two-dimensional code according to the user identity, the two-dimensional code being decoded to obtain the user identity; and overlap the two-dimensional code on a designated video frame that plays the video play identity.

By using the method and the electronic device for protecting video digital copyrights provided by the embodiments of the present disclosure, the two-dimensional code is generated through the user identity, and the two-dimensional code is overlapped in the video frame. When the video is bootlegged, a bootlegged frame will contain the two-dimensional code; therefore, the user identity may be obtained from the two-dimensional code very conveniently, thus ascertaining a bootlegging source. Resources needed for coding and decoding the two-dimensional code are far fewer than resources consumed by a watermark way; therefore, cost for preventing bootlegging can be greatly reduced.

### BRIEF DESCRIPTION OF THE FIGURES

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a working flow chart of a method for protecting video digital copyrights in accordance with some embodiments of the present disclosure;

FIG. 2 is a system schematic diagram of a system for protecting video digital copyrights in accordance with some embodiments of the present disclosure;

FIG. 3 is a working flow chart of a method for protecting video digital copyrights in accordance with some embodiments of the present disclosure;

FIG. 4 is a system module diagram of a system for protecting video digital rights in accordance with some embodiments of the present disclosure; and

FIG. 5 is a hardware structural diagram of an electronic device for performing a method for protecting video digital copyrights in accordance with some embodiments of the present disclosure.

### DETAILED DESCRIPTION OF THE INVENTION

The present disclosure will be further described in details hereinafter with reference to the figures and specific embodiments.

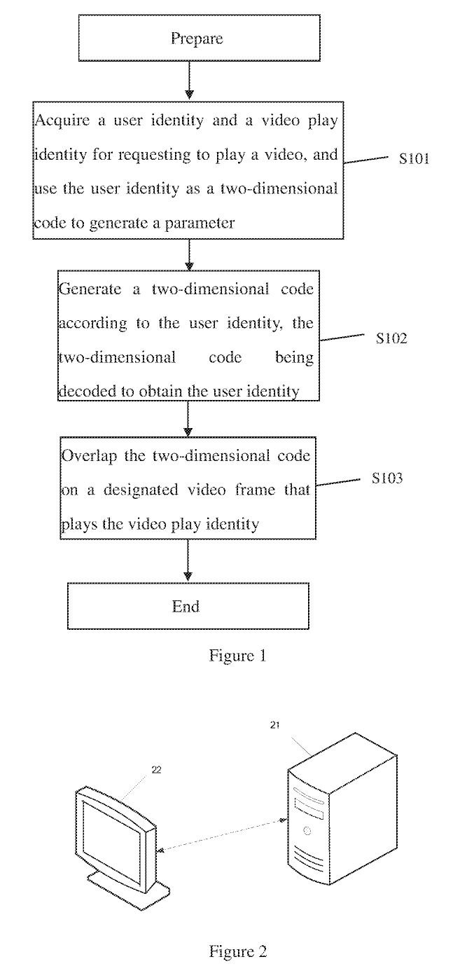

FIG. 1 is a working flow chart of a method for protecting video digital copyrights according to a first embodiment of the present disclosure, comprising:

step S101, comprising: acquiring a user identity and a video play identity for requesting to play a video, and using the user identity as a two-dimensional code to generate a parameter;

step S102, comprising: generating a two-dimensional code according to the user identity, the two-dimensional code being decoded to obtain the user identity; and

step S103, comprising: overlapping the two-dimensional code on a designated video frame that plays the video play identity.

Step S101 is generally triggered when a user requests to play a video. In step S102, the two-dimensional code is generated according to the user identity. Compared with a watermark employed in the prior art, much fewer resources are needed for coding and decoding the two-dimensional code; therefore, various devices with lower device resource configurations can used to conduct coding and decoding operations, such that the entire cost for preventing bootlegging is reduced. Meanwhile, because fewer resources are needed for coding the two-dimensional code, coding the two-dimensional code and overlapping the video frame may be directly performed on a playing device. To reduce the resources consumed by the playing device, the two-dimensional code may also be generated on a server, while the two-dimensional code acquired from the server is overlapped on the playing device.

In step S103, the two-dimensional code is overlapped on the video frame that plays the video; if a third party without obtaining copyright authorization bootlegs the video, the two-dimensional code in the frame bootlegged may be acquired and decoded to obtain the user identity, thus knowing where the third party without obtaining copyright authorization bootlegs the video. The video may either be acquired locally or acquired from the server. Moreover, before acquiring the video, the user identity may be verified, and the video is acquired only after the user identity passes the verification. The video may be played in existing various manners. For example, the video is downloaded to the local and then played, or the video on the server is played in a streaming media manner. Because a display volume of the two-dimensional code itself is relatively smaller, a viewing effect will not be influenced when the two-dimensional code is overlapped on the video frame. Meanwhile, because fewer resources are consumed in a way of overlapping the two-dimensional code on the frame that plays the video, the two-dimensional code can be overlapped in real time even during playing a live video of a live program, such that the copyrights of the live program are protected, and a bootlegging behavior is prevented.

Because resources needed for coding and decoding the two-dimensional code are far fewer than resources consumed by a watermark way employed in the prior art, the embodiments of the present disclosure can greatly reduce the cost for preventing bootlegging, and can protect the copyrights of the live program.

In a second embodiment of the present disclosure, the video play identity is a video play website.

In this embodiment, step S102 specifically comprises: generating the two-dimensional code according to the user identity and the video play website, the two-dimensional code being decoded to obtain the user identity and the video play website; and

step S103 specifically comprises: overlapping the two-dimensional code on a video frame that plays a video acquired from the video play website.

In this embodiment, a video is acquired from a designated website according to the video play website, wherein the video may either be complete video data, or streaming media video data. An existing DRM technology is employed to protect the copyrights of the video during transmission. After the video has been acquired, the two-dimensional code generated according to the user identity and the video play website is acquired, e.g. t.cn/abcde?uid=xxx, wherein t.cn/abcde is a video play website, and xxx is the user identity.

The two-dimensional code of this embodiment comprises the video play website and the user identity; therefore, a remote video bootlegging behavior can be traced back conveniently.

In a third embodiment of the present disclosure, the video play identity is a local video path comprising a video name.

In this embodiment, step S102 specifically comprises: generating the two-dimensional code according to the user identity and the video name, the two-dimensional code being decoded to obtain the user identity and the video name; and

step S103 specifically comprises: overlapping the two-dimensional code on a video frame that plays a video acquired from the local video path.

The embodiment achieves the protection for copyrights of the local video data. The two-dimensional code is generated according to the user identity and the video name; therefore, a remote video bootlegging behavior can be traced back conveniently.

In a fourth embodiment of the present disclosure, step S103 specifically comprises:

overlapping a floating layer containing the two-dimensional code on a video frame that plays the video, parts in the floating layer excluding the two-dimensional code being transparent.

According to this embodiment, by overlapping the floating layer containing the two-dimensional code on the video frame that plays the video, the video and the two-dimensional code are not needed to be pressed in advance, so that the resource utilization is reduced, and the cost for preventing bootlegging is decreased.

In a fifth embodiment of the present disclosure, the user identity comprises a user login name, a machine identity of a device that plays the video, and a network identity of the device that plays the video.

Wherein, the machine identity of the device comprises a sequence number of a TV set, an international mobile equipment identity (International Mobile Equipment Identity, IMEI) of a mobile device (for example, a mobile phone), or the like. The network identity of the device may be an IP address of the device or a media access control (MAC) address (also called as physical address) of the device.

By incorporating the foregoing user login name, the machine identity of the device that plays the video, or the network identity of the device that plays the video into the two-dimensional code for coding, a bootlegging behavior can be traced more effectively.

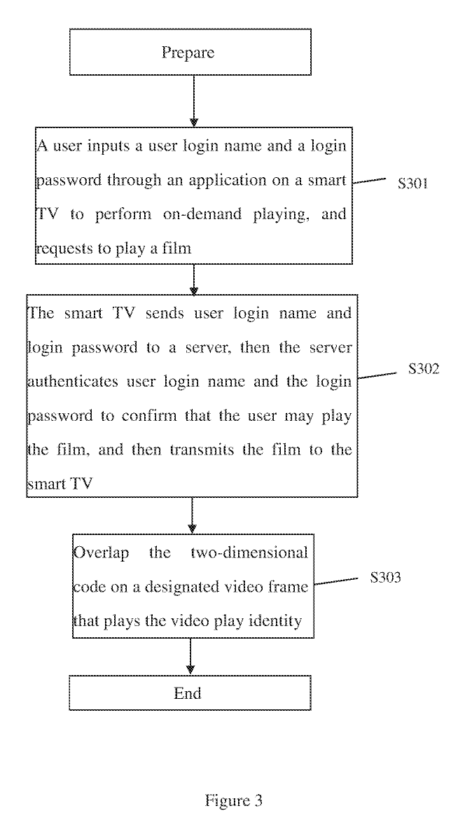

FIG. 2 is a system schematic diagram of a system for protecting video digital copyrights according to a sixth embodiment of the present disclosure, comprising: a server 21 and a smart TV 22, wherein the smart TV 22 mainly executes the method for protecting video digital copyrights according to the embodiments of the present disclosure, and a working flow chart is shown in FIG. 3, specifically comprising the following steps.

In step S301, a user inputs a user login name and a login password through an application on the smart TV 22 as shown in FIG. 2 to perform on-demand playing, and requests to play a film;

in step S302, the smart TV 22 sends the user login name and the login password to the server 21 as shown in FIG. 2, then the server 21 authenticates the user login name and the login password to confirm that the user may play the film, and then transmits the film to the smart TV 22;

in step S303, the smart TV 22 starts to play the film by the application. During playing the film, the application generates a two-dimensional code and overlaps the two-dimensional code on the video frame, wherein the two-dimensional code contains a user identity.

The identity may be a user login name, a sequence number of the smart TV or a mac address of a wireless card. The two-dimensional code is usually a website used for user interaction, e.g. t.cn/abcde, which is added with the user identity thereafter, such as t.cn/abcde?uid=xxx, wherein xxx is the user identity.

When the film is pirated (for example, recorded by a high definition camera), the video frame will contain the two-dimensional code. The video frame containing the two-dimensional code is intercepted, and the two-dimensional code is decoded to obtain the user identity such as xxx in t.cn/abcde?uid=xxx.

This embodiment of the present disclosure can greatly reduce the cost for preventing bootlegging, and can achieve the protection for the copyrights of live programs.

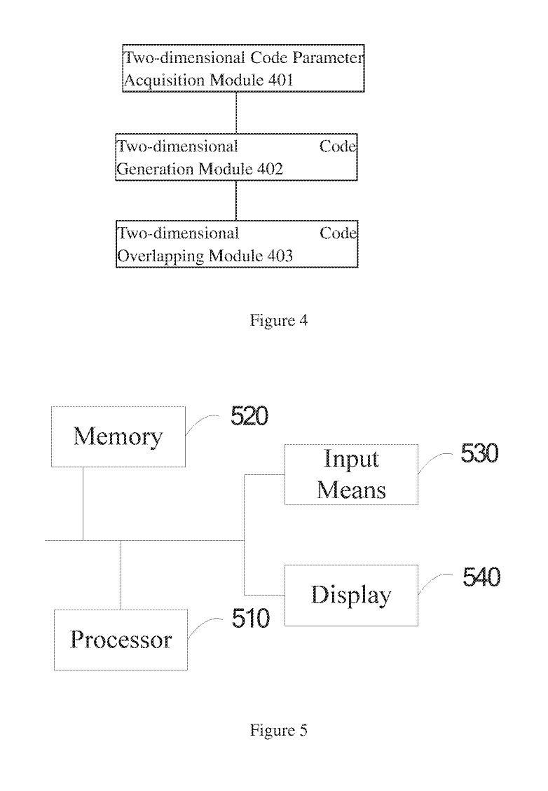

FIG. 4 is a system module diagram of a system for protecting video digital copyrights according to a seventh embodiment of the present disclosure, comprising:

a two-dimensional code parameter acquisition module 401 configured to acquire a user identity and a video play identity for requesting to play a video, and use the user identity as a two-dimensional code to generate a parameter;

a two-dimensional code generation module 402 configured to generate a two-dimensional code according to the user identity, the two-dimensional code being decoded to obtain the user identity; and

a two-dimensional code overlapping module 403 configured to overlap the two-dimensional code on a designated video frame that plays the video play identity.

This embodiment of the present disclosure can greatly reduce the cost for preventing bootlegging, and can achieve the protection for the copyrights of live programs.

In an eighth embodiment of the present disclosure, the video play identity is a video play website.

In this embodiment, the two-dimensional code generation module 402 is specifically configured to generate the two-dimensional code according to the user identity and the video play website, the two-dimensional code being decoded to obtain the user identity and the video play website; and

the two-dimensional code overlapping module 403 is specifically configured to overlap the two-dimensional code on a video frame that plays a video acquired from the video play website.

The two-dimensional code of this embodiment comprises the video play website and the user identity; therefore, a remote video bootlegging behavior can be traced back conveniently.

In a ninth embodiment, the video play identity is a local video path comprising a video name.

In this embodiment, the two-dimensional code generation module 402 is specifically configured to generate the two-dimensional code according to the user identity and the video name, the two-dimensional code being decoded to obtain the user identity and the video name; and

the two-dimensional code overlapping module 403 is specifically configured to overlap the two-dimensional code on a video frame that plays a video acquired from the local video path.

This embodiment achieves the protection for the copyrights of the local video data. The two-dimensional code is generated according to the user identity and the video name; therefore, a remote video bootlegging behavior can be traced back conveniently.

In a tenth embodiment, the playing module 403 is specifically configured to overlap a floating layer containing the two-dimensional code on a video frame that plays the video, parts in the floating layer excluding the two-dimensional code being transparent.

According to this embodiment, by overlapping the floating layer containing the two-dimensional code on the video frame that plays the video, the video and the two-dimensional code are not needed to be pressed in advance, so that the resource utilization is reduced, and the cost for preventing bootlegging is decreased.

In an eleventh embodiment, the user identity comprises a user login name, a machine identity of a device that plays the video, and a network identity of the device that plays the video.

By incorporating the foregoing user login name, the machine identity of the device that plays the video, or the network identity of the device that plays the video into the two-dimensional code for coding, a bootlegging behavior can be traced more effectively.

A twelfth embodiment of the present disclosure provides A non-transitory computer-readable storage medium storing executable instructions that, when executed by an electronic device with a touch-sensitive display, cause the electronic device to execute a method for protecting video digital copyrights in accordance with any one of the foregoing embodiments of the present disclosure.

FIG. 5 is a hardware structure diagram of an electronic device for protecting video digital copyrights according to a thirteenth embodiment of the present disclosure. As shown in FIG. 5, the electronic device includes one or more processors 510, a memory 520 and a display 540. FIG. 5 takes one processor 510 as an example.

The electronic device for protecting video digital copyrights may further include an input means 530.

The processor 510, the memory 520, the input means 530 and the display 540 may be connected via a bus or in other ways. In FIG. 5, these elements are connected via a bus.

The memory 520 can be used as a nonvolatile computer-readable storage medium, which can store a nonvolatile software program, a nonvolatile computer-executable program, and respective modules. For example, the medium stores program instructions/modules for protecting video digital copyrights according to the embodiments of the present disclosure, such as the two-dimensional code parameter acquisition module 401, the two-dimensional code generation module 402 and the two-dimensional code overlapping module 403. The processor 510 executes the nonvolatile software program, instructions and/or modules stored within the memory 520, so as to perform several functional applications and data processing, particularly, perform the method for protecting video digital copyrights according to the above embodiments as above.

The memory 520 may include a storage program zone and a storage data zone. The storage program zone may store an operating system and at least one application program for achieving respective functions. The storage data zone may store data created according to the usage of the icon sequencing device. In addition, the memory 520 may further include a high speed random access memory and a nonvolatile memory, e.g. at least one of a disk storage device, a flash memory or other nonvolatile solid storage device. In some embodiments, the memory 520 may include a remote memory remotely located relative to the processor 510, and this remote memory may be connected, via a network, to the icon sequencing device for an intelligent television desktop. For example, the network includes but is not limited within internet, intranet, local area network, mobile communication network and any combination thereof.

The input means 530 can receive an input user-clicking, and generate a signal input associated with a user setting and a functional controlling of a user device for protecting video digital copyrights. The display 540 may include a display device such as a displaying screen, for displaying results of performing the method for protecting video digital copyrights.

One or more storage modules are stored within the memory 520. When said one or more storage modules are operated by one or more processors 510, the method for protecting video digital copyrights in accordance with the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

In the embodiments of the present disclosure, the smart TV mainly comprises a processor, a memory, a communication assembly, a displaying screen, and the like.

In particular, the detailed codes in the above-mentioned methods are stored in the memory, executed by the processor, communicated via the communication assembly, and displayed on the displaying screen.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

The above embodiments regarding devices are only exemplary, wherein units as separated elements may be or not be separated physically, elements as units being illustrated may be or not be physical units. These elements or units may be located in one place, or may be distributed over a plurality of network units. A part or all of the modules in the system may be selected according to an actual requirement to achieve the objectives of the solutions in the embodiments of the present disclosure.

Through the above description of the embodiments, those skilled in the art may clearly understand that each embodiment may be achieved in a manner of combining software and a necessary common hardware platform, and certainly may also be achieved by hardware. Based on such understanding, the foregoing technical solutions essentially, or the part contributing to the prior art may be implemented in a form of a software product. The computer software product may be stored in a computer-readable storage medium such as a ROM/RAM, a diskette, an optical disk or the like, and includes several instructions for instructing a computer device (which may be a personal computer, a server, or a network device so on) to execute the method according to each embodiment or some parts of the embodiments.

It should be noted that, the above embodiments are only used to illustrate the technical solutions of the present disclosure, but do not tend to limit the present disclosure. Although the present invention has been illustrated in detail by referring to the above embodiments, the skilled in the art should understand that, the technical solutions recorded by the above embodiments may be modified, or parts of the technical features may be replaced equally. Such modifications or replacements do not make the respective technical solutions to substantially depart from the spirit and scope of the embodiments of the present disclosure.

What is claimed is:

1. An electronic device for protecting video digital copyrights, comprising:
at least one processor; and
a memory communicably connected with the at least one processor for storing instructions executable by the at least one processor, wherein execution of the instructions by the at least one processor causes the at least one processor to:
acquire a user identity and a video play identity for requesting to play a video, and use the user identity as a two-dimensional code to generate a parameter;
generate a two-dimensional code according to the user identity, the two-dimensional code being decoded to obtain the user identity; and
overlap the two-dimensional code on a designated video frame that plays the video play identity.

2. The electronic device for protecting video digital copyrights according to claim 1, wherein the video play identity is a video play website; and
the processor is further configured to generate the two-dimensional code according to the user identity and the video play website, the two-dimensional code being decoded to obtain the user identity and the video play website; and
overlap the two-dimensional code on a video frame that plays a video acquired from the video play website.

3. The electronic device for protecting video digital copyrights according to claim 1, wherein the video play identity is a local video path containing a video name; and
the processor is further configured to generate the two-dimensional code according to the user identity and the video name, the two-dimensional code being decoded to obtain the user identity and the video name; and
overlap the two-dimensional code on a video frame that plays a video acquired from the local video path.

4. The electronic device for protecting video digital copyrights according to claim 1, wherein the processor is further configured to overlap a floating layer containing the two-dimensional code on a video frame that plays the video, parts in the floating layer excluding the two-dimensional code being transparent.

5. The electronic device for protecting video digital rights according to claim 1, wherein the user identity comprises a user login name, a machine identity of a device that plays the video, and a network identity of the device that plays the video.

6. A method for protecting video digital copyrights by an electronic device, comprising:
acquiring a user identity and a video play identity for requesting to play a video, and using the user identity as a two-dimensional code to generate a parameter;
generating a two-dimensional code according to the user identity, the two-dimensional code being decoded to obtain the user identity; and
overlapping the two-dimensional code on a designated video frame that plays the video play identity.

7. The method for protecting video digital copyrights according to claim 6, wherein the video play identity is a video play website;
the generating the two-dimensional code according to the user identity, the two-dimensional code being decoded to obtain the user identity, comprises: generating the two-dimensional code according to the user identity and the video play website, the two-dimensional code being decoded to obtain the user identity and the video play website; and
the overlapping the two-dimensional code on the designated video frame that plays the video play identity comprises: overlapping the two-dimensional code on a video frame that plays a video acquired from the video play website.

8. The method for protecting video digital copyrights according to claim 7, wherein the video play identity is a local video path containing a video name;
the generating the two-dimensional code according to the user identity, the two-dimensional code being decoded to obtain the user identity, comprises: generating the two-dimensional code according to the user identity and the video name, the two-dimensional code being decoded to obtain the user identity and the video name; and
the overlapping the two-dimensional code on the designated video frame that plays the video play identity comprises: overlapping the two-dimensional code on a video frame that plays a video acquired from the local video path.

9. The method for protecting video digital copyrights according to claim 7, wherein the overlapping the two-dimensional code on the designated video frame that plays the video play identity comprises:
overlapping a floating layer containing the two-dimensional code on a video frame that plays the video, parts in the floating layer excluding the two-dimensional code being transparent.

10. The method for protecting video digital copyrights according to claim 6, wherein the user identity comprises a user login name, a machine identity of a device that plays the video, and a network identity of the device that plays the video.

11. A non-transitory computer-readable storage medium storing executable instructions that, when executed by an electronic device with a touch-sensitive display, cause the electronic device to:
acquire a user identity and a video play identity for requesting to play a video, and using the user identity as a two-dimensional code to generate a parameter;
generate a two-dimensional code according to the user identity, the two-dimensional code being decoded to obtain the user identity; and
overlap the two-dimensional code on a designated video frame that plays the video play identity.

12. The storage medium according to claim 11, wherein the video play identity is a video play website;
the generating the two-dimensional code according to the user identity, the two-dimensional code being decoded to obtain the user identity, comprises: generating the two-dimensional code according to the user identity and the video play website, the two-dimensional code being decoded to obtain the user identity and the video play website; and
the overlapping the two-dimensional code on the designated video frame that plays the video play identity comprises: overlapping the two-dimensional code on a video frame that plays a video acquired from the video play website.

13. The storage medium according to claim 11, wherein the video play identity is a local video path containing a video name;
the generating the two-dimensional code according to the user identity, the two-dimensional code being decoded to obtain the user identity, comprises: generating the two-dimensional code according to the user identity and the video name, the two-dimensional code being decoded to obtain the user identity and the video name; and
the overlapping the two-dimensional code on the designated video frame that plays the video play identity comprises: overlapping the two-dimensional code on a video frame that plays a video acquired from the local video path.

14. The storage medium according to claim 11, wherein the overlapping the two-dimensional code on the designated video frame that plays the video play identity comprises:
overlapping a floating layer containing the two-dimensional code on a video frame that plays the video, parts in the floating layer excluding the two-dimensional code being transparent.

15. The storage medium according to claim 11, wherein the user identity comprises a user login name, a machine identity of a device that plays the video, and a network identity of the device that plays the video.
